(19) United States
(12) Patent Application Publication
(10) Pub. No.: US 2010/0073561 A1
(43) Pub. Date: Mar. 25, 2010

(54) Receiver, portable device, receiving method, computer program and receiving system

(75) Inventor: Masatoshi Onikubo, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/586,020

(22) Filed: Sep. 16, 2009

(30) Foreign Application Priority Data
Sep. 19, 2008 (JP) P2008-240276

(51) Int. Cl. H04N 5/46; H04N 5/50

(52) U.S. Cl. 348/555; 348/731; 348/570; 348/E05.114; 348/E05.097

(57) ABSTRACT

A receiver which includes: a 12-segment broadcast receiving unit configured to receive 12-segment broadcast signals of a predetermined channel among a plurality of channels; an information receiving unit configured to receive channel switching instruction information, transmitted from a portable device that receives 1-segment broadcast signals, for instructing switching to a channel corresponding to a channel currently being viewed on the portable device; and a channel control unit configured to control, on the basis of the channel switching instruction information received by the information receiving unit, switching of a channel that the 12-segment broadcast receiving unit receives.

### CROSS-REFERENCE TO RELATED APPLICATION

The present application claims priority from Japanese Patent Application No. JP 2008-240276 filed in the Japanese Patent Office on Sep. 19, 2008, the entire content of which is incorporated herein by reference.

### BACKGROUND OF THE INVENTION

1. Field of the Invention

The present invention relates to a receiver, a portable device, a receiving method, a computer program and a receiving system. More particularly, the invention relates to a receiver, a portable device, a receiving method, a computer program and a receiving system which enable a user to view a channel on a receiver that receives a 12-segment broadcast corresponding to a channel currently being viewed on a portable device that receives a 1-segment broadcast in a simple operation.

2. Description of the Related Art

Integration Services Digital Broadcasting-Terrestrial (ISDB-T) is a standard for digital terrestrial television broadcasting in Japan (see, for example, JP-A-2005-20340).

A principle feature of the ISDB-T standard is 13 multiplexed transmission units called “segments” within an approximately 6-MHz bandwidth (i.e., each channel) allocated to each broadcasting company. A broadcasting company simulcasts, on the allocated 13 segments, broadcasts for home television receivers (i.e., a high-definition television broadcast or a standard broadcast) and broadcasts for portable devices. The term “simulcast” is a portmanteau of simultaneous and broadcast, which is also called simultaneous broadcasting. The simulcast refers to broadcasting the same content in plural manners at the same time.

In the ISDB-T, the segments are allocated for a signal modulation system for portable devices to produce signals highly resistant to noise and multipass, and for a signal modulation system for home television receivers to produce signals less highly resistant to noise. The separately modulated signals are multiplexed and broadcast. Usually, there is a trade-off between the resistance to noise or multipass and a bit rate to be transmitted. Content to be broadcast is modulated in different modulation systems on the basis of image quality: the modulation system for portable devices (simple animation broadcasting) and the modulation system for home television receivers (high-definition television broadcasting or standard broadcasting).

FIG. 1 schematically illustrates a terrestrial digital broadcasting service disclosed in Japanese Unexamined Patent Application Publication (JP-A) No. 2005-20340. The example illustrated in FIG. 1 includes a transmission antenna 11 of a broadcasting company for terrestrial digital broadcasting, a terrestrial digital broadcast signal 12, a home television broadcast receiver 13 and a portable device 14. Examples of the portable device 14 include a personal digital assistant (PDA) and a mobile phone.

The terrestrial digital broadcast signal 12 corresponding to each channel (5.75 MHz) transmitted from the transmitting antenna 11 includes 13 segments, T1 to T13. A broadcasting company transmits, for example, a high-definition television broadcast or a standard broadcast for the television broadcasting receiver 13 using twelve segments (T1 to T6 and T8 to T13) and transmits a broadcast for the portable device 14 using the remaining segment (T7).

The broadcast for the portable device 14 is referred to as a “1-segment broadcast” that is transmitted at a low bit rate with a smaller frame number and a smaller frame size as compared with that of the broadcast for the television broadcast receiver 3. The broadcast for the television broadcast receiver 3 is made in the following various transmission patterns. For example, three standard broadcasts of standard definition television (SDTV) each occupying four segments; a high-definition television broadcast of high definition television (HDTV) occupying twelve segments; and a combination of a high-definition television broadcast occupying nine segments and a standard broadcast occupying three segments. These are collectively called a “12-segment broadcast.”

The differently-modulated same program is broadcast in a “1-segment broadcast” and a “12-segment broadcast.” A user can view the same broadcast program on the television broadcast receiver 13 as a 12-segment broadcast and on the portable device 14 as a 1-segment broadcast.

Recently, an increasingly large number of portable devices 14, such as mobile phones, have a function that enables them to receive a 1-segment broadcast.

A user viewing a program on a portable device 14 that receives a 1-segment broadcast may wish to continuously view the program on the television broadcast receiver 13 as a 12-segment broadcast. In this case, the user should know channel information of the program currently being viewed on the portable device 14 and selects the corresponding channel on the television broadcast receiver 13 using, for example, a remote controller.

It is therefore desirable to allow a user to view a channel on a television broadcast receiver corresponding to a channel currently being viewed on a portable device in a simple operation.

### SUMMARY OF THE INVENTION

A receiver according to a first embodiment of the invention includes: a 12-segment broadcast receiving unit configured to receive 12-segment broadcast signals of a predetermined channel among a plurality of channels; an information receiving unit configured to receive channel switching instruction information, transmitted from a portable device that receives 1-segment broadcast signals, for instructing switching to a channel corresponding to a channel currently being viewed on the portable device; and a channel control unit configured to control, on the basis of the channel switching instruction information received by the information receiving unit, switching of a channel that the 12-segment broadcast receiving unit receives.

The channel switching instruction information may include information about a channel currently being viewed and information about a program name.

The receiver may further include a broadcast determining unit which is configured to determine, on the basis of the information about the program name included in the channel switching instruction information and information about the program name included in data of the 12-segment broadcast signal, whether simultaneous broadcasting is provided in the channel currently being viewed on the portable device. The channel control unit may be configured to control, on the basis of the channel switching instruction information, switching of the channel that the 12-segment broadcast receiving unit receives if the broadcast determining unit determines that simultaneous broadcasting is being provided.

The receiver may further include a display control unit which is configured to control a display describing that no simultaneous broadcasting is being provided if the broadcast determining unit determines that no simultaneous broadcasting is being provided.

A receiving method of a first embodiment of the invention includes the steps of: receiving, by a receiver, 12-segment broadcast signals of a predetermined channel among a plurality of channels; receiving channel switching instruction information, transmitted from a portable device that receives 1-segment broadcast signals, for instructing switching to a channel corresponding to a channel currently being viewed on the portable device; and controlling, by the receiver, on the basis of the received channel switching instruction information, switching of a channel to be received.

A computer program according to a first embodiment of the invention causes a receiver, which includes a 12-segment broadcast receiving unit configured to receive 12-segment broadcast signals of a predetermined channel among a plurality of channels, to execute a process which includes the steps of: receiving channel switching instruction information, transmitted from a portable device that receives 1-segment broadcast signals, for instructing switching to a channel corresponding to a channel currently being viewed on the portable device; and controlling, on the basis of the received channel switching instruction information, switching of a channel that the 12-segment broadcast receiving unit receives.

In the first embodiment of the invention, channel switching instruction information, transmitted from a portable device that receives 1-segment broadcast signals, for instructing switching to a channel corresponding to a channel currently being viewed on the portable device is received; and switching of the channel to receive is controlled on the basis of the received channel switching instruction information.

A portable device according to a second embodiment of the invention includes: a 1-segment broadcast receiving unit configured to receive 1-segment broadcast signals of a predetermined channel among a plurality of channels; a channel information acquiring unit configured to acquire, upon user operation, channel information received by the 1-segment broadcast receiving unit; and an information transmission unit configured to transmit, to a receiver which receives 12-segment broadcast signals, channel switching instruction information for switching to a channel currently being viewed, the channel switching instruction information being generated on the basis of the channel information acquired by the channel information acquiring unit.

The channel switching instruction information may include information about a channel currently being viewed and information about a program name.

A receiving method according to a second embodiment of the invention includes the steps of: a portable device receiving 1-segment broadcast signals of a predetermined channel among a plurality of channels; the portable device acquiring, upon user operation, information about a channel being received; and the portable device transmitting, to a receiver which receives 12-segment broadcast signals, channel switching instruction information for switching to a channel currently being viewed, the channel switching instruction information being generated on the basis of the acquired channel information.

A program according to a second embodiment of the invention causes a portable device, which includes a 1-segment broadcast receiving unit configured to receive 1-segment broadcast signals of a predetermined channel among a plurality of channels, to executes a process including the steps of: acquiring, upon user operation, information about a channel being received by the 1-segment broadcast receiving unit; and transmitting, to a receiver which receives 12-segment broadcast signals, channel switching instruction information for switching to a channel currently being viewed, the channel switching instruction information being generated on the basis of the acquired channel information.

In the second embodiment of the invention, channel information being received is acquired upon user operation; and channel switching instruction information for instructing switching to a channel corresponding to a channel currently being viewed generated on the basis of the acquired channel information is transmitted to a receiver which receives 12-segment broadcast signals.

A receiving system according to a third embodiment of the invention includes a portable device and a receiver. The portable device includes a 1-segment broadcast receiving unit configured to receive 1-segment broadcast signals of a predetermined channel among a plurality of channels; a channel information acquiring unit configured to acquire, upon user operation, information about a channel being received by the 1-segment broadcast receiving unit; and an information transmission unit configured to transmit, to a receiver which receives 12-segment broadcast signals, channel switching instruction information for switching to a channel currently being viewed, the channel switching instruction information being generated on the basis of the channel information acquired by the channel information acquiring unit. The receiver includes a 12-segment broadcast receiving unit configured to receive 12-segment broadcast signals of a predetermined channel among a plurality of channels; an information receiving unit configured to receive the channel switching instruction information transmitted from the portable device; and a channel control unit configured to control, on the basis of the channel switching instruction information received by the information receiving unit, switching of the channel that the 12-segment broadcast receiving unit receives.

In the third embodiment of the invention, the portable device receives 1-segment broadcast signals of a predetermined channel among a plurality of channels; acquire channel information being received upon user operation; and transmit, to a receiver which receives 12-segment broadcast signals, channel switching instruction information for instructing switching to a channel corresponding to a channel currently being viewed generated on the basis of the acquired channel information. The receiver receives 12-segment broadcast signals of a predetermined channel among a plurality of channels; receives the channel switching instruction information transmitted from the portable device; and controls switching of a channel to receive on the basis of the received channel switching instruction information.

According to the first embodiment of the invention, the user can view the programs of the 12-segment broadcast. According to the first embodiment of the invention, a user can switch a program of the 12-segment broadcast to a program viewed in the 1-segment broadcast on the portable device in a simple operation.

According to the second embodiment of the invention, the user can view the programs of the 1-segment broadcast. According to the second embodiment of the invention, the receiver which receives 12-segment broadcast signals can be directed to be switched in a simple operation to a program currently being viewed in the 1-segment broadcast.

According to the third embodiment of the invention, the user can view the same program as the 1-segment broadcast and as the 12-segment broadcast. It is also possible to provide the receiver which receives the 12-segment broadcast signal with an instruction to switch to the program currently being viewed on the portable device as the 1-segment broadcast. In this manner, switching can be made in a simple operation.

### BRIEF DESCRIPTION OF THE DRAWINGS

FIG. 1 schematically illustrates a terrestrial digital broadcasting service;

FIG. 2 is a block diagram of an exemplary configuration of a receiving system according to an embodiment of the invention;

FIG. 3 illustrates an exemplary configuration of an exterior of a portable device;

FIG. 4 is a block diagram of an exemplary electric configuration of the portable device;

FIG. 5 is a flowchart of a channel switching instruction transmission process of the portable device;

FIG. 6 is a flowchart of a channel switching instruction receiving process of a receiver;

FIG. 7 is a flowchart of another exemplary channel switching instruction reception of a receiver;

FIG. 8 illustrates an exemplary message to be displayed; and

FIG. 9 is a block diagram of an exemplary configuration of computer hardware.

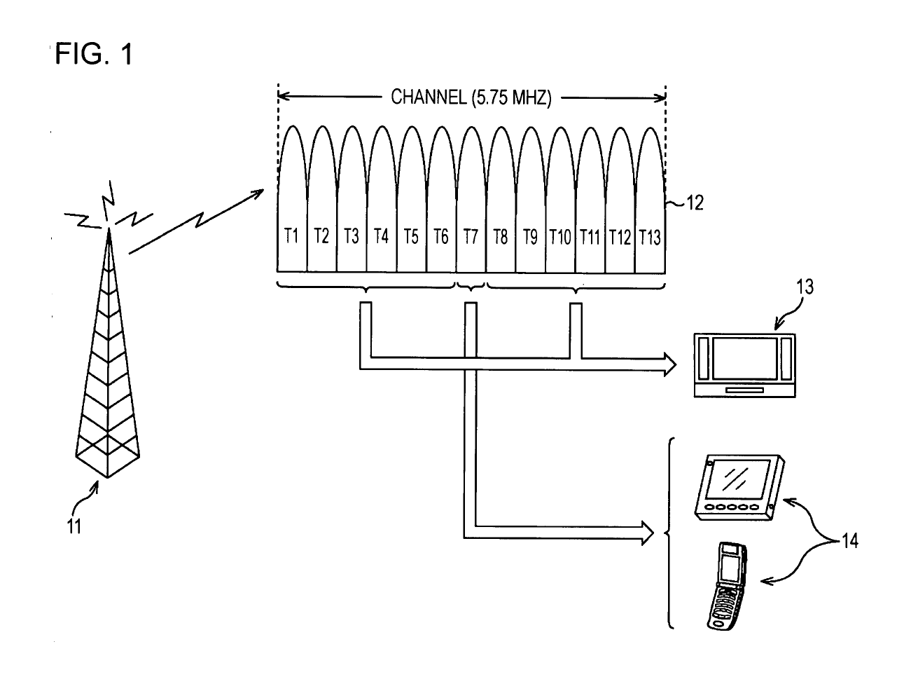

### DESCRIPTION OF THE PREFERRED EMBODIMENTS

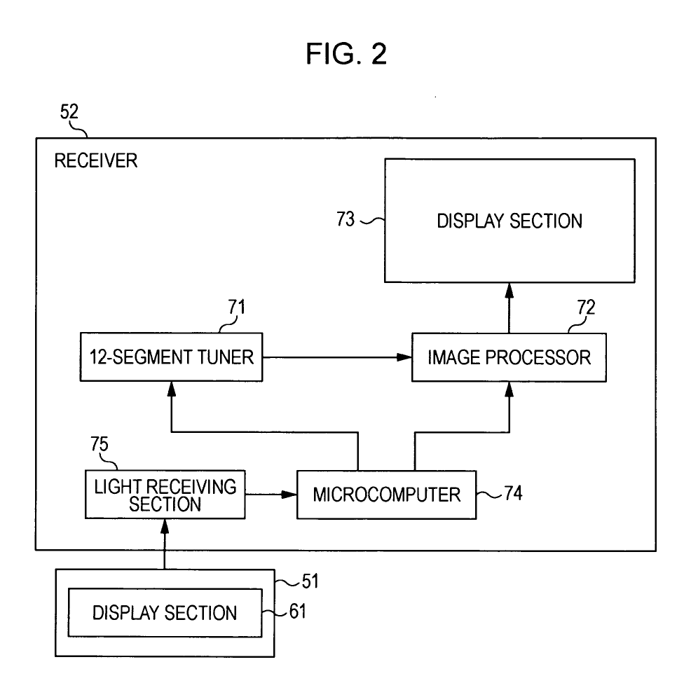

FIG. 2 is a block diagram of an exemplary configuration of a receiving system according to an embodiment of the invention.

The receiving system includes a portable device 51 which receives a 1-segment broadcast included in a digital broadcast and a receiver 52 which receives a 12-segment broadcast included in the digital broadcast.

A terrestrial digital broadcast signal corresponding to each channel (5.75 MHz) transmitted from a transmitting antenna of a broadcasting company includes 13 segments. A broadcasting company transmits, for example, a high-definition television broadcast or a standard broadcast for the receiver using twelve segments (hereinafter, referred to as “12-segment broadcast”) and transmits a broadcast for the portable device 51 using the remaining segment (hereinafter, referred to as “1-segment broadcast”).

The differently-modulated same program is broadcast in the “1-segment broadcast” and the “12-segment broadcast.” Such broadcasting is also called simultaneous broadcasting. Regarding simultaneously broadcast programs, a user can view the same program on the receiver 52 as a 12-segment broadcast and on the portable device 51 as a 1-segment broadcast.

A receiving system illustrated in FIG. 2 allows a user to view, on the receiver 52 as the 12-segment broadcast, the same program currently being viewed on the portable device 51 as the 1-segment broadcast.

Examples of the portable device 51 include a personal digital assistant (PDA) and a mobile phone. The portable device 51 includes a display section 61, such as a liquid crystal display (LCD), and an output terminal connected to a speaker or a headset, which is not illustrated.

The portable device 51 receives broadcast signals at an antenna, which is not illustrated, and decodes signals for the 1-segment broadcast on a predetermined channel among the received broadcast signals. The portable device 51 sends image signals obtained from decoded signals of the 1-segment broadcast to the display section 61 and sends audio signals to the output terminal connected to the speaker or the headset.

The display section 61 displays an image of a program of the 1-segment broadcast. The speaker and the headset, which are not illustrated, output sound of the program of the 1-segment broadcast. With this configuration, the user can view the program of the 1-segment broadcast.

The portable device 51 generates, upon user operation, control signals for instructing the receiver 52 to make channel switching to a channel corresponding to the 1-segment broadcast channel currently being viewed by the user. The portable device 51 transmits the generated control signals to the receiver 52 via, for example, infrared communication.

Examples of the receiver 52 include a home television receiver. The receiver 52 includes a 12-segment tuner 71, an image processor 72, a display section 73, a microcomputer 74 and a light receiving section 75.

The 12-segment tuner 71 decodes, under the control of the microcomputer 74, 12-segment broadcast signals of a predetermined channel among the broadcast signals received by an antenna, which is not illustrated. The 12-segment tuner 71 then sends image signals obtained from the decoded signals to the image processor 72.

The image processor 72 executes predetermined signal processing on the image signals from the 12-segment tuner 71, and sends the processed image signals to the display section 73. The image processor 72 generates, under the control of the microcomputer 74, a predetermined image and sends signals corresponding to the image to the display section 73. Audio signals obtained from the decoded 12-segment broadcast signals are subject to predetermined processing in an audio processor, which is not illustrated, and then sent to a speaker, which is not illustrated.

The display section 73 includes an LCD which displays an image of the program of the 12-segment broadcast. A speaker, which is not illustrated, outputs sound of the program of the 12-segment broadcast. With this configuration, a user can view the program of the 12-segment broadcast.

The microcomputer 74 is a main controller that controls operation of the entire receiver 52. The microcomputer 74 controls, on the basis of operation signals supplied from an input section, which is not illustrated, the 12-segment tuner 71 and the image processor 72 to switch to a predetermined channel or to have a menu screen displayed on the display section 73.

The microcomputer 74 further controls, on the basis of control signals supplied from the light receiving section 75 for instructing channel switching, the 12-segment tuner 71 and the image processor 72 to switch to a predetermined channel or to have a predetermined message image displayed on the display section 73.

The light receiving section 75 receives control signals supplied from the portable device 51 for instructing channel switching and sends the received control signals to the microcomputer 74.

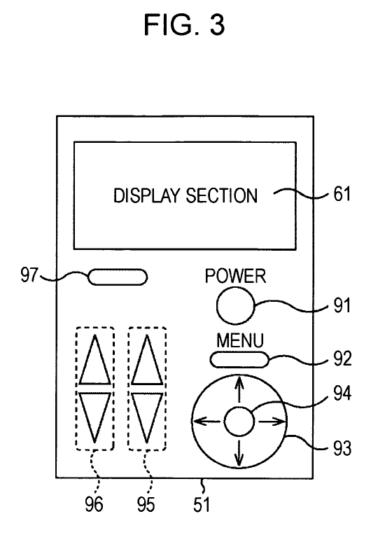

FIG. 3 illustrates an exemplary configuration of an exterior of the portable device 51.

In the example of FIG. 3, the portable device 51 includes, on a housing surface on which the display section 61 is provided, a power button 91, a menu button 92, a cross key 93, a determination button 94, a volume control button 95, a channel select button 96 and a channel switching instruction button 97.

The power button 91 is used to turn the portable device 51 on. When the user presses the power button 91, the entire portable device 51 is started, an image corresponding to the decoded image signals is displayed on the display section 61 and sound corresponding to the decoded audio signal is output from the speaker, which is not illustrated.

The menu button 92 is used to allow a menu screen to be displayed on the display section 61 so that the user can make various setups or operations.

The cross key 93 is used to move a cursor vertically or horizontally to select an item on the menu screen displayed on the display section 61.

The determination button 94 is provided at the center of the cross key 93 and is used to enter an item selected with the cursor on the menu screen displayed on the display section 61.

The volume control button 95 is used to adjust the audio volume.

The channel select button 96 is used to select a desired channel from plural channels.

The channel switching instruction button 97 is used to make an instruction to switch the channel on the receiver 52 to a channel corresponding to the channel currently being viewed on the portable device 51.

Although the channel switching instruction button 97 is provided on the housing of the portable device 51 in the example of FIG. 3, a button corresponding to the channel switching instruction button 97 can be displayed on the menu screen of the display section 61 instead. In this case, when the user selects the button displayed on the menu screen using the cross key 93 and determines using the determination button 94, an instruction is made to switch the channel of the receiver 52 to a channel corresponding to the channel currently being viewed on the portable device 51.

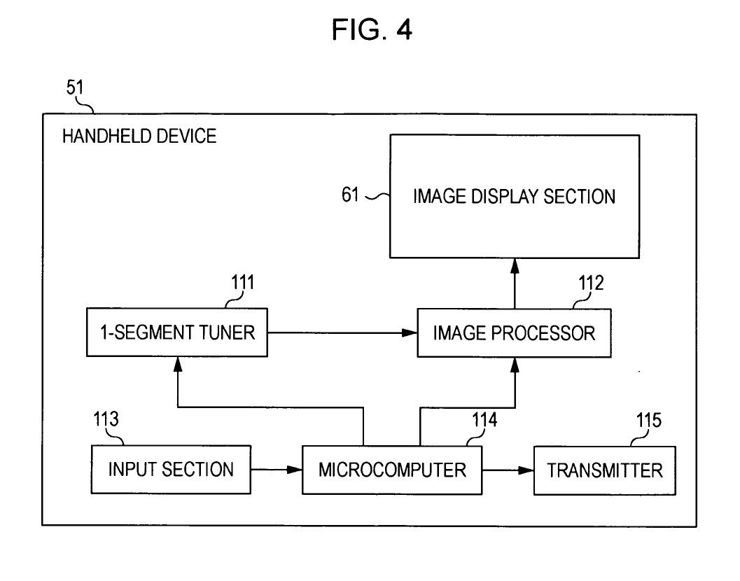

FIG. 4 is a block diagram of an exemplary electric configuration of the portable device 51.

In the example illustrated in FIG. 4, the portable device 51 includes, other than the display section 61 illustrated in FIG. 2, a 1-segment tuner 111, an image processor 112, an input section 113, a microcomputer 114 and a transmitter 115.

The 1-segment tuner 111 decodes, under the control of the microcomputer 114, 1-segment broadcast signals of a predetermined channel among the broadcasting signals received by an antenna, which is not illustrated. The 1-segment tuner 111 then sends image signals obtained from the decoded signals to the image processor 112.

The image processor 112 executes predetermined signal processing to the image signals from the 1-segment tuner 111 and sends the processed image signals to the display section 61. The image processor 112 generates basis of control of the microcomputer 114, a menu screen and sends image signals corresponding to the menu screen to the display section 61.

Audio signals obtained from the decoded 1-segment broadcast signals are subject to predetermined processing in an audio processor, which is not illustrated, and then sent to an output terminal to a speaker, which is not illustrated, or a headset, which is not illustrated.

The input section 113 may include various buttons and keys illustrated in FIG. 2 or a touch panel laminated on the display section 61. When a button which is included in the input section 113 is pressed by the user, the input section 113 sends operation signals corresponding to pressed button to the microcomputer 114.

The microcomputer 114 is a main controller that controls the entire operation of the portable device 51. The microcomputer 114 controls, on the basis of operation signals supplied from the input section 113, the 1-segment tuner 111 and the image processor 112 to switch to a predetermined channel or to have a menu screen displayed on the display section 61.

When the user presses the channel switching instruction button 97 illustrated in FIG. 3, the microcomputer 114 acquires information about the channel currently being viewed on the portable device 51. The microcomputer 114 then generates control signals as information to instruct channel switching of the receiver 52 to a channel corresponding to the channel currently being viewed on the portable device 51 and sends the control signals to the transmitter 115.

The transmitter 115 transmits, under the control of the microcomputer 114, the generated control signals to the receiver 52 via, for example, infrared communication.

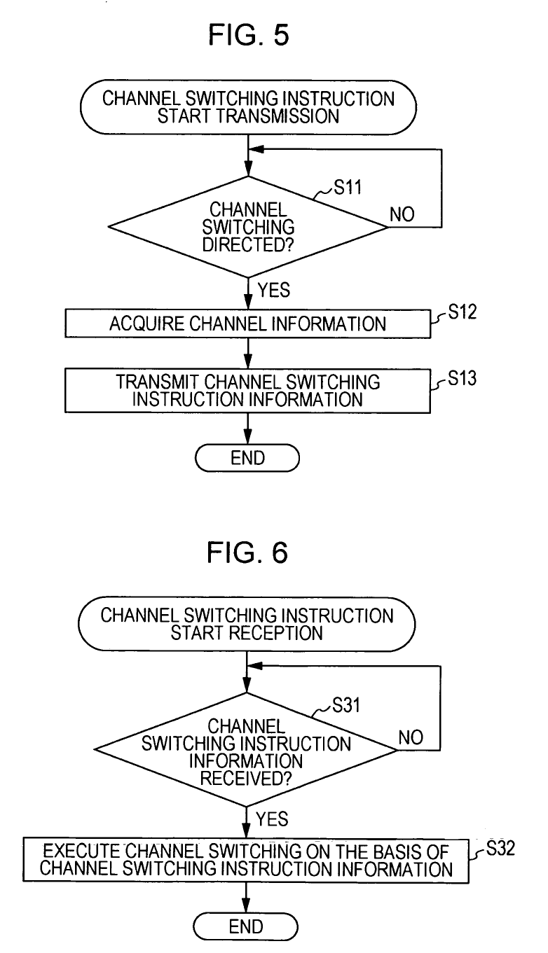

Next, with reference to a flowchart of FIG. 5, a channel switching instruction transmission process by the portable device 51 will be described.

In step S11, the microcomputer 114 determines whether channel switching of the receiver 52 is directed by the user. If it is determined that the channel switching of the receiver 52 has not been directed in step S11, the routine returns to step S11 to repeat the process of step S11.

That is, in step S11, the microcomputer 114 stands by until channel switching of the receiver 52 is directed by user.

As an exemplary user operation to switch the channel of the receiver 52 to a channel corresponding to the channel currently being viewed on the portable device 51, the user presses the channel switching instruction button 97 illustrated in FIG. 3.

If the user presses a button included in the input section 113, the input section 113 sends operation signals corresponding to the pressed channel switching instruction button 97 to the microcomputer 114.

In step S11, the microcomputer 114 determines, on the basis of the operation signal corresponding to the channel switching instruction button 97, that the user has directed channel switching of the receiver 52 and the routine proceeds to step S12.

In step S12, the microcomputer 114 acquires information about the channel currently being viewed from the 1-segment tuner 111. The microcomputer 114 then generates, on the basis of the acquired information about the channel currently being viewed, control signals as the channel switching instruction information about a channel corresponding to the channel currently being viewed and sends the control signals to the transmitter 115.

The transmitter 115 transmits, under the control of the microcomputer 114, the control signals as the channel switching instruction information supplied from the microcomputer 114 to the receiver 52 via, for example, infrared communication.

Next, with reference to a flowchart of FIG. 6, a channel switching instruction reception process by the receiver 52 performed corresponding to the channel switching instruction transmission process of FIG. 5 will be described.

In step S31, the light receiving section 75 determines whether the channel switching instruction information from the portable device 51 has been received. If it determined that the channel switching instruction information from the portable device 51 has not been received in step S31, the routine returns to step S31 to repeat the process.

That is, in step S31, the light receiving section 75 stands by until the control signals as the channel switching instruction information from the portable device 51 is received.

The light receiving section 75 receives control signals supplied from the portable device 51 as the channel switching instruction information. In this case, the light receiving section 75 determines that the channel switching instruction information from the portable device 51 has been received in step S31 and sends the received control signals as the channel switching instruction information to the microcomputer 74.

In step S32, the microcomputer 74 controls, on the basis of the channel switching instruction information received from the light receiving section 75, the 12-segment tuner 71 and the image processor 72 to execute channel switching of the receiver 52. That is, the microcomputer 74 controls the 12-segment tuner 71 and the image processor 72 to switch the channel currently being received to the channel currently being viewed on the portable device 51.

In response to the switching, the 12-segment tuner decodes the 12-segment broadcast signal of the channel directed by the microcomputer 74 among the broadcasting signals received by an antenna, which is not illustrated, and sends the obtained image signals to the image processor 72. The image processor 72 executes predetermined signal processing to the image signals from the 12-segment tuner 71 and sends the processed image signals to the display section 73.

Audio signals obtained from the decoded 12-segment broadcast signals of the channel directed by the microcomputer 74 are subject to predetermined processing in an audio, which is not illustrated, processor and then sent to an output terminal to a speaker, which is not illustrated, or a headset, which is not illustrated.

With this configuration, images of the program of a channel corresponding to the channel currently being viewed on the portable device 51 is displayed on the display section 73 of the receiver 52, and sound of the program of a channel corresponding to the channel currently being viewed on the portable device 51 is output from a speaker, which is not illustrated.

Note that the method the portable device 51 transmits, upon user operation, the control signals as the channel switching instruction information, i.e., a communication method between the portable device 51 and the receiver 52 is not particularly limited. For example, infrared communication and wireless communication can be employed as the communication method.

Although the control signals as the channel switching instruction information transmitted by the portable device 51 may include only the channel information as control signals from a remote controller, which is not illustrated, for controlling the receiver 52, the invention is not limited thereto. That is, the control signals as the channel switching instruction information transmitted by the portable device 51 may also include, in addition to the channel information, a program name and a genre on the basis of electronic television program guide information which exists in the data of the digital broadcast.

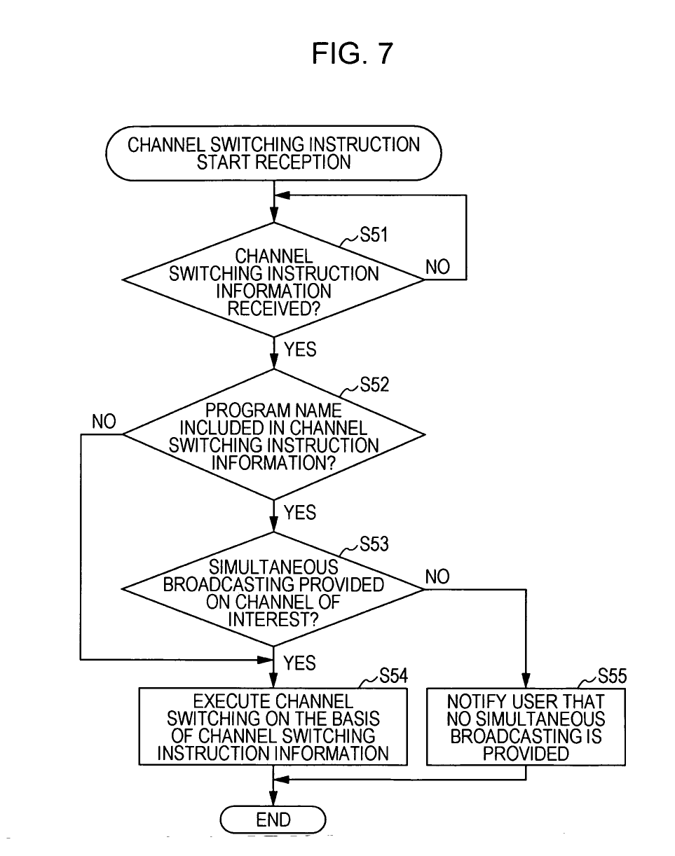

Next, with reference to a flowchart illustrated in FIG. 7, a channel switching instruction reception process of the receiver 52 when the control signals as the channel switching instruction information including the information about the channel and the program name is transmitted from the portable device 51 will be described.

Since processes in steps S51 and S54 in FIG. 7 are substantially similar to those in steps S31 and S 32 illustrated in FIG. 6, detailed description thereof will be omitted to avoid redundancy.

In step S51, the light receiving section 75 stands by until the channel switching instruction information from the portable device 51 is received.

The light receiving section 75 receives control signals supplied from the portable device 51 as the channel switching instruction information. In this case, the light receiving section 75 determines that the channel switching instruction information from the portable device 51 has been received in step S51 and sends the control signals as the channel switching instruction information supplied from the portable device 51 to the microcomputer 74.

In step S52, the microcomputer 74 determines whether a program name is included in the channel switching instruction information supplied from the portable device 51. If it is determined that no program name is included in step S52, the process in step S53 is skipped and the routine proceeds to step S54.

If it is determined that a program name is included in the channel switching instruction information supplied from the portable device 51 in step S52, the microcomputer 74 acquires electronic television program guide information included in the data of the 12-segment broadcast from the 12-segment tuner 71. Then, in step S53, the microcomputer 74 collates the program name included in the data of the 12-segment broadcast to the program name of the channel switching instruction information to determine whether simultaneous broadcasting is being made in the channel (program) of interest.

If it is determined that simultaneous broadcasting is being made in the channel (program) of interest in step S53, the routine proceeds to step S54. In step S54, the microcomputer 74 controls, on the basis of the channel switching instruction information from the light receiving section 75, the 12-segment tuner 71 and the image processor 72 to execute channel switching of the receiver 52.

If, on the other hand, it is determined that simultaneous broadcasting is not being made in the channel (program) of interest in step S53, the routine proceeds to step S55.

In step S55, the microcomputer 74 notifies the user that no simultaneous broadcasting is provided.

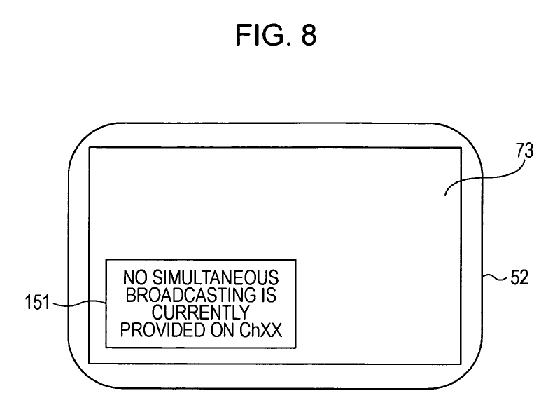

In particular, in step S55, the microcomputer 74 controls the image processor 72 to display a message on the display section 73. The image processor 72 generates a message image and sends image signals corresponding to the message image to the display section 73. A message image 151 as illustrated in FIG. 8 is displayed on the display section 73.

In an example illustrated in FIG. 8, the message image 151 “No simultaneous broadcasting is currently provided on ChXX” is displayed on a bottom left corner of the display section 73 of the receiver 52.

In this manner, the user can be notified that no 12-segment broadcast of the channel corresponding to the channel currently being viewed on the portable device 51 is provided and thus is not able to be viewed on the receiver 52.

An image of a channel currently displayed on the receiver 52 before the channel switching instruction is made may be displayed on a background of the message image 151. In this case, the message image 151 is superimposed on the image of the channel in the image processor 72.

As described above, the receiver 52 can acquire the electronic television program guide information existing in the data of the digital broadcast. If the receiver 52 receives the channel information, the program name and the genre from the portable device 51, the receiver 52 can determine whether simultaneous broadcasting is provided in the 12-segment broadcast and in the 1-segment broadcast in the channel of interest.

If no simultaneous broadcasting is provided, the user can be notified that no simultaneous broadcasting is provided by the message image 151 displayed on the display section 73 of the receiver 52 as illustrated in FIG. 8.

As described above, according to this receiving system, the channel of the receiver 52 can be switched to the channel corresponding to the channel currently being viewed on the portable device 51 in a simple operation of the portable device 51.

With this configuration, the user can view the channel on the receiver 52 corresponding to the channel currently being viewed on the portable device 51 that receives the 1-segment broadcast without any complex operations on the receiver 52 whenever the user wishes to do the same.

A series of processes described above may also be implemented either by the hardware or by the software. If the series of processes is to be executed by the software, a program constituting the software may be installed from a program recording medium to a computer incorporated in a dedicated hardware, or a general-purpose personal computer which can execute various functions with various programs installed therein.

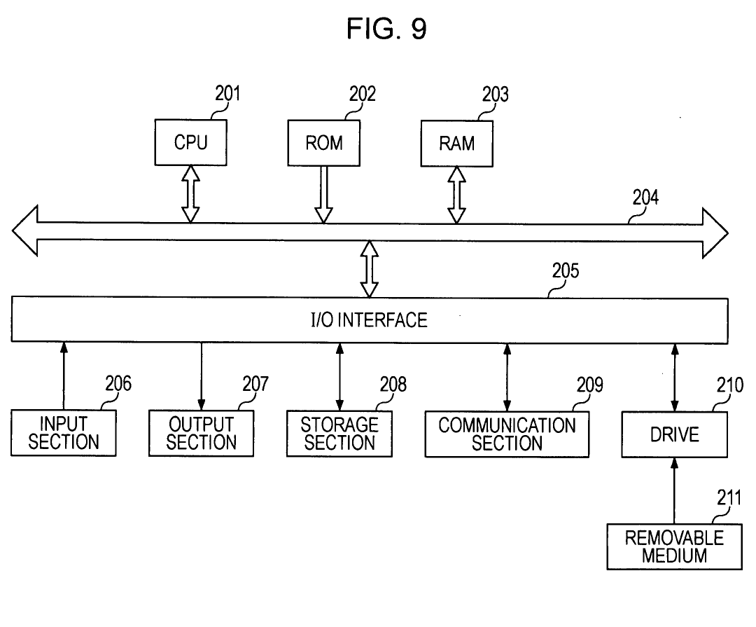

FIG. 9 is a block diagram showing an exemplary configuration of the computer hardware which executes a series of processes described above according to a program.

A central processing unit (CPU) 201, a read only memory (ROM) and a random access memory (RAM) 203 are mutually connected by a bus 204.

An I/O interface 205 is further connected to the bus 204. An input section 206, an output section 207, a storage section 208, a communicating section 209 and a drive 210 are connected to the I/O interface 205. The input section 206 may include a keyboard, a mouse and a microphone. The output section 207 may include a display and a speaker. The storage section 208 may include a hard disk and a nonvolatile memory. The communicating section 209 may include a network interface. The drive 210 drives a removable medium 211, such as an optical disc and a semiconductor memory.

In the thus-configured computer, the series of processes described above is executed when, for example, the CPU 201 causes a computer program recorded on the storage section 208 to be loaded on the RAM 203 for execution via the I/O interface 205 and the bus 204.

The computer program executed by the CPU 201 is recorded, for example on a removable medium 211, or is provided via a wired or wireless transmission medium, such as local area network, Internet and digital broadcast and installed in the storage section 208.

The computer program to be executed by the computer may be a time-series program in which processes are executed in the described order or may be a program in which processes are executed in parallel or upon request, e.g., when invoked.

The term “system” used herein represents an entire apparatus which includes plural devices.

It is to be understood that the foregoing description of the embodiment of the invention is illustrative only and that various modification may be made without departing from the sprit and scope of the invention.

What is claimed is:

1. A receiver comprising: a 12-segment broadcast receiving unit configured to receive 12-segment broadcast signals of a predetermined channel among a plurality of channels;
an information receiving unit configured to receive channel switching instruction information, transmitted from a portable device that receives 1-segment broadcast signals, for instructing switching to a channel corresponding to a channel currently being viewed on the portable device; and
a channel control unit configured to control, on the basis of the channel switching instruction information received by the information receiving unit, switching of a channel that the 12-segment broadcast receiving unit receives.

2. The receiver according to claim 1, wherein the channel switching instruction information includes information about a channel currently being viewed and information about a program name.

3. The receiver according to claim 2, further comprising a broadcast determining unit configured to determine, on the basis of the information about the program name included in the channel switching instruction information and information about the program name included in data of the 12-segment broadcast signal, whether simultaneous broadcasting is provided in the channel currently being viewed on the portable device,
wherein the channel control unit is configured to control, on the basis of the channel switching instruction information, switching of the channel that the 12-segment broadcast receiving unit receives if the broadcast determining unit determines that simultaneous broadcasting is being provided.

4. The receiver according to claim 3, further comprising a display control unit configured to control a display describing that no simultaneous broadcasting is being provided if the broadcast determining unit determines that no simultaneous broadcasting is being provided.

5. A receiving method comprising the steps of:
receiving, by a receiver, 12-segment broadcast signals of a predetermined channel among a plurality of channels;
receiving channel switching instruction information, transmitted from a portable device that receives 1-segment broadcast signals, for instructing switching to a channel corresponding to a channel currently being viewed on the portable device; and
controlling, by the receiver, on the basis of the received channel switching instruction information, switching of a channel to be received.

6. A computer program which causes a receiver, which includes a 12-segment broadcast receiving unit configured to receive 12-segment broadcast signals of a predetermined channel among a plurality of channels, to execute a process comprising the steps of:
receiving channel switching instruction information, transmitted from a portable device that receives 1-segment broadcast signals, for instructing switching to a channel corresponding to a channel currently being viewed on the portable device; and
controlling, on the basis of the received channel switching instruction information, switching of a channel that the 12-segment broadcast receiving unit receives.

7. A portable device comprising: a 1-segment broadcast receiving unit configured to receive 1-segment broadcast signals of a predetermined channel among a plurality of channels;
a channel information acquiring unit configured to acquire, upon user operation, channel information received by the 1-segment broadcast receiving unit; and
an information transmission unit configured to transmit, to a receiver which receives 12-segment broadcast signals, channel switching instruction information for switching to a channel currently being viewed, the channel switching instruction information being generated on the basis of the channel information acquired by the channel information acquiring unit.

8. The portable device according to claim 7, wherein the channel switching instruction information includes information about a channel currently being viewed and information about a program name.

9. A receiving method comprising the steps of:
a portable device receiving 1-segment broadcast signals of a predetermined channel among a plurality of channels;
the portable device acquiring, upon user operation, information about a channel being received; and
the portable device transmitting, to a receiver which receives 12-segment broadcast signals, channel switching instruction information for switching to a channel currently being viewed, the channel switching instruction information being generated on the basis of the acquired channel information.

10. A computer program which causes a portable device, which includes a 1-segment broadcast receiving unit configured to receive 1-segment broadcast signals of a predetermined channel among a plurality of channels, to execute a process comprising the steps of:
acquiring, upon user operation, information about a channel being received by the 1-segment broadcast receiving unit; and
transmitting, to a receiver which receives 12-segment broadcast signals, channel switching instruction information for switching to a channel currently being viewed, the channel switching instruction information being generated on the basis of the acquired channel information.

11. A receiving system comprising a portable device and a receiver,
the portable device including:
a 1-segment broadcast receiving unit configured to receive 1-segment broadcast signals of a predetermined channel among a plurality of channels;
a channel information acquiring unit configured to acquire, upon user operation, information about a channel being received by the 1-segment broadcast receiving unit; and
an information transmission unit configured to transmit, to a receiver which receives 12-segment broadcast signals, channel switching instruction information for switching to a channel currently being viewed, the channel switching instruction information being generated on the basis of the channel information acquired by the channel information acquiring unit, and
the receiver including:
a 12-segment broadcast receiving unit configured to receive 12-segment broadcast signals of a predetermined channel among a plurality of channels;
an information receiving unit configured to receive the channel switching instruction information transmitted from the portable device; and
a channel control unit configured to control, on the basis of the channel switching instruction information received by the information receiving unit, switching of the channel that the 12-segment broadcast receiving unit receives.
